(19) United States
(12) Patent Application Publication
(10) Pub. No.: US 2023/0198246 A1
(43) Pub. Date: Jun. 22, 2023

(54) ELECTRONIC DEVICE

(71) Applicant: SONY GROUP CORPORATION, TOKYO (JP)

(72) Inventors: TATSUYA FURUYA, TOKYO (JP); HIDETOSHI AKASAWA, TOKYO (JP)

(21) Appl. No.: 17/999,406

(22) PCT Filed: Jun. 2, 2020
(86) PCT No.: PCT/JP2020/021740

§ 371 Date: Nov. 21, 2022

(51) Int. Cl. H02H 7/18; H01M 10/42

(52) U.S. Cl. CPC H02H 7/18; H01M 10/425; H02J 7/00302

(57) ABSTRACT

An electronic device has a battery cell, a protection circuit substrate, and a heat-conduction tape. A thermistor is mounted on the protection circuit substrate. The heat-conduction tape bonds the battery cell to a chassis, is extended from the battery cell to a thermistor mount part of the protection circuit substrate, and is connected to the thermistor mount part directly or via a heat-conduction material.

### FIELD

The present invention relates to an electronic device.

### BACKGROUND

A battery pack is provided with a protection circuit for protecting battery cells from overcharge, over discharge, and overcurrent. A thermistor for detecting the cell temperature of a battery cell is mounted on a substrate on which a protection circuit is formed. When the detected temperature of the thermistor exceeds a set range, a malfunction is determined, and a charge current or a discharge current is shut off.

### CITATION LIST

### Patent Literature

Patent Literature 1: JP 2015-202046 A

### SUMMARY

### Technical Problem

If the capacity of the battery cell becomes large, large Joule heat is generated by a current which flows in the protection circuit. The heat generated in the protection circuit may adversely affect the measurement result of the thermistor. In such a case, it is difficult to appropriately control charge and discharge of the battery cell based on the measurement result of the thermistor.

Therefore, the present disclosure proposes an electronic device capable of detecting the cell temperature with high accuracy.

### Solution to Problem

According to the present disclosure, an electronic device is provided that comprises: a battery cell; a protection circuit substrate on which a thermistor is mounted; and a heat-conduction tape bonding the battery cell to a chassis, extended from the battery cell to a thermistor mount part of the protection circuit substrate, and connected to the thermistor mount part directly or via a heat-conduction material.

### BRIEF DESCRIPTION OF DRAWINGS

FIG. 1 is a schematic diagram of an electronic device of a first embodiment.

FIG. 2 is a schematic diagram of the electronic device of the first embodiment.

FIG. 3 is a schematic diagram of the electronic device of the first embodiment.

FIG. 4 is a schematic diagram of a tape main-body part.

FIG. 5 is a diagram describing experimental examples of heat dissipation effects.

FIG. 6 is a diagram describing experimental examples about measurement errors in cell temperatures.

FIG. 7 is a diagram describing experimental examples about measurement errors in cell temperatures.

FIG. 8 is a schematic diagram of an electronic device of a second embodiment.

FIG. 9 is a schematic diagram of an electronic device of a third embodiment.

FIG. 10 is a diagram illustrating an electronic device according to a first modification example.

FIG. 11 is a diagram illustrating an electronic device according to a second modification example.

### DESCRIPTION OF EMBODIMENTS

Hereinafter, embodiments of the present disclosure will be described in detail based on drawings. In the following embodiments, the same parts are denoted by the same reference signs to omit redundant descriptions.

Note that the description will be given in the following order.

### [1. First Embodiment]

### [1-1. Configuration of Electronic Device]

### [1.2. Experimental Examples of Heat Dissipation Effects]

[1-3. Experimental Examples about Measurement Accuracy in Cell Temperatures]

### [1-4. Effects]

### [2. Second Embodiment]

### [3. Third Embodiment]

### [4. Modification Examples]

### 1. First Embodiment

### [1-1. Configuration of Electronic Device]

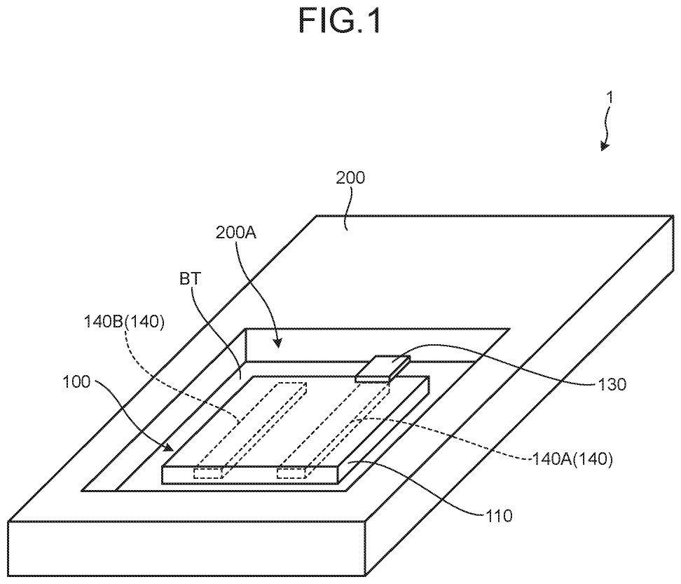

FIG. 1 to FIG. 3 are schematic diagrams of an electronic device 1 of a first embodiment.

As illustrated in FIG. 1, the electronic device 1 has a battery pack 100 and a chassis 200. The electronic device 1 is, for example, a smartphone. The chassis 200 is provided with a housing part 200A, which houses the battery pack 100. The battery pack 100 is fixed to a bottom surface BT of the housing part 200A by heat-conduction tapes 140.

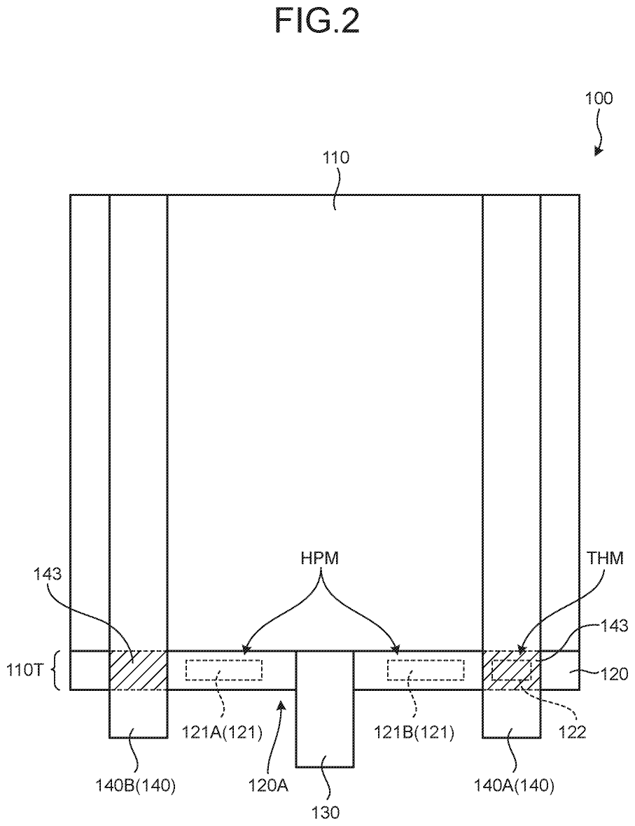

As illustrated in FIG. 2, the battery pack 100 has a battery cell 110, a protection circuit substrate 120, Flexible Printed Circuits (FPC) 130, and the heat-conduction tapes 140.

The battery cell 110 is, for example, a laminated battery in which an electrode assembly is sealed with an exterior material. The electrode assembly has a structure in which a positive electrode, a negative electrode, and a separator are stacked and wound. The protection circuit substrate 120 is connected to the battery cell 110. The protection circuit substrate 120 is provided with a protection circuit 120A, which protects the battery cell 110 from overcharge, over discharge, and overcurrent. On the protection circuit substrate 120, one or more heat-generating part(s) 121, which is caused to generate heat by a current flowing in the protection circuit 120A, is mounted. Examples of the heat-generating part 121 include an IC chip and FET. In the present embodiment, as the one or more heat-generating part(s) 121, an IC chip 121A and an IC chip 121B are provided.

A thermistor 122 is mounted on the protection circuit substrate 120. The thermistor 122 detects the temperature near the battery cell 110. When the detected temperature of the thermistor 122 exceeds the set range, the protection circuit 120A determines a malfunction and stops charge and discharge.

A terrace part 110T is formed at an end of the battery cell 110 to which the protection circuit substrate 120 is connected. The terrace part 110T is a part including only an exterior material and an electrode tab and is thinner than the other part in which the positive electrode, the negative electrode, the separator, and the exterior material are stacked. The protection circuit substrate 120 is connected to a positive electrode tab and a negative electrode tab of the battery cell 110 and then is bent over the terrace part 110T with the surface, on which the heat-generating part 121 and the thermistor 122 are mounted, inside. As a result, the protection circuit substrate 120 is housed on the terrace part 110T. An end of the FPC 130 in the opposite side of the side to which the protection circuit 120A is connected is folded back. The protection circuit substrate 120 is connected to external equipment via the FPC 130.

The one or more heat-conduction tape(s) 140 are pasted onto the battery cell 110. The heat-conduction tape 140 is disposed between the battery cell 110 and the chassis 200 and bonds the battery cell 110 to the chassis 200. In the present embodiment, as the one or more heat-conduction tape(s) 140, a first heat-conduction tape 140A and a second heat-conduction tape 140B are provided. The first heat-conduction tape 140A and the second heat-conduction tape 140B are disposed along two sides of the battery cell 110 which are orthogonal to the terrace part 110T. The first heat-conduction tape 140A and the second heat-conduction tape 140B extend from a first end (the terrace part 110T) of the battery cell 110, to which the protection circuit substrate 120 is connected, toward a second end of the battery cell 110, which is in the opposite side of the first end.

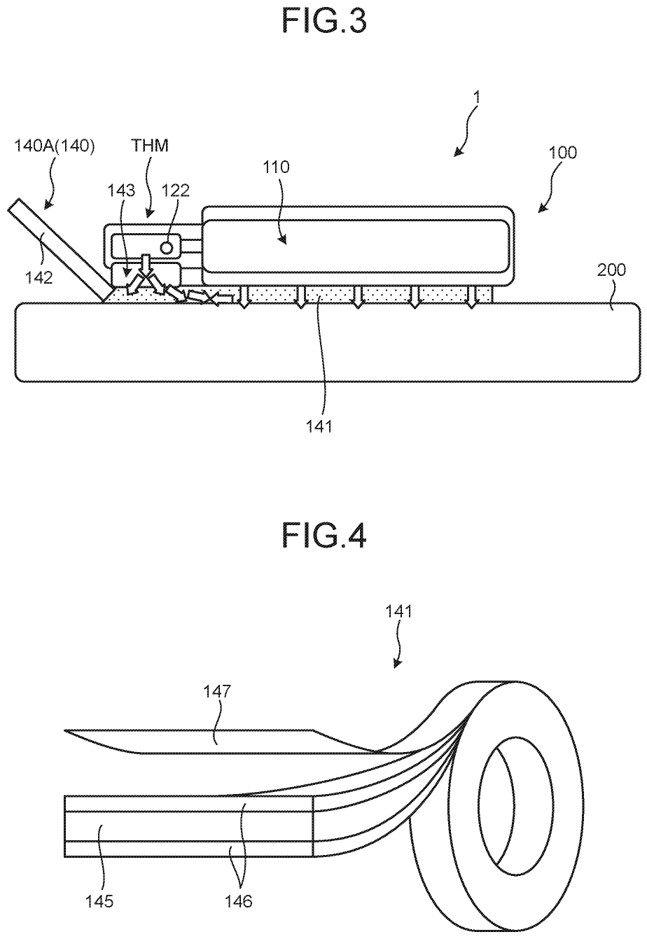

As illustrated in FIG. 2 and FIG. 3, the first heat-conduction tape 140A and the second heat-conduction tape 140B are connected, via a heat-conduction material 143, to a region of the protection circuit substrate 120 excluding a heat-generating-part mount part THM. For example, the first heat-conduction tape 140A is extended from the battery cell 110 to the thermistor mount part THM of the protection circuit substrate 120 and is connected to the thermistor mount part THM via the heat-conduction material 143. The heat-conduction material 143 is selectively provided in a region excluding the heat-generating-part mount part THM. Therefore, the heat generated by the heat-generating part is not directly transmitted to the thermistor mount part THM via the heat-conduction material 143.

As illustrated in FIG. 3, the heat-conduction tape 140 has a tape main-body part 141 and a tab part 142. The tape main-body part 141 is disposed between the battery cell 110 and the chassis 200 and bonds the battery cell 110 to the chassis 200. The tab part 142 is connected to a distal end of the tape main-body part 141.

FIG. 4 is a schematic diagram of the tape main-body part 141.

The tape main-body part 141 has adhesive layers 146 on both surfaces of an extensible insulating base material 145. Heat-conductive fillers are dispersed in the adhesive layers 146. The surface of the adhesive layer 146 is protected by release paper 147. When bonding is to be carried out, the releasing paper 147 is released.

Examples of the insulating base material 145 include foamed-structure-based materials such as acrylic foam and polyethylene foam, rubber-based materials such as silicon rubber, and highly-ductile-resin-based materials such as polypropylene-based materials and polyethylene-based materials. The highly-ductile-resin-based material is not easily ruptured even when the material is pulled by strong force. Therefore, the highly-ductile-resin-based material can be suitably used as the insulating base material 145. Examples of the highly-ductile-resin-based material include polyethylene (ductility: 50 to 1000%), polypropylene (ductility: 200 to 700%), polyethylene telephthalate (ductility: 20%), polyimide (ductility: 4%), and nylon (ductility: 60%). As the polypropylene-based materials, both of non-ductile polypropylene (CPP) and biaxially-oriented polypropylene (OPP) can be used.

Examples of the heat-conductive fillers include silicon carbide (SiC), aluminum nitride (AlN), alumina-based materials (Al₂O₃), silicon nitride (Si₃N₄), cermet (TiC·TiN), yttria (Y₂O₃), boron nitride (BN), ferrite-based materials (Ni—Zn, Mn—Zn-based), and carbon-based materials (carbon, graphite, diamond, carbon nanotube, graphene).

Examples of the heat-conduction material 143 include extensible materials such as silicon resin, carbon-based resin (graphite tape, etc.), and rubber. For example, flexible metals such as indium, lead, and lithium can be also used as the heat-conduction material 143. Any of non-extensible materials such as ceramics (alumina, yttria, etc.), nitrides (aluminum nitride, boron nitride, titanium nitride, etc.), carbides (silicon carbide, etc.), carbon-based materials (diamond, graphite, graphene, carbon nanotubes), and single metals or metal alloys (ferrite-based metals such as Ni—Zn, Mn—Zn) other than the above described flexible metals can be also used as the heat-conduction material 143.

By virtue of the above described structure, the heat conductivity of the heat-conduction tape 140 (the tape main-body part 141) is 0.1 W/mK or higher.

### 1.2. Experimental Examples of Heat Dissipation Effects

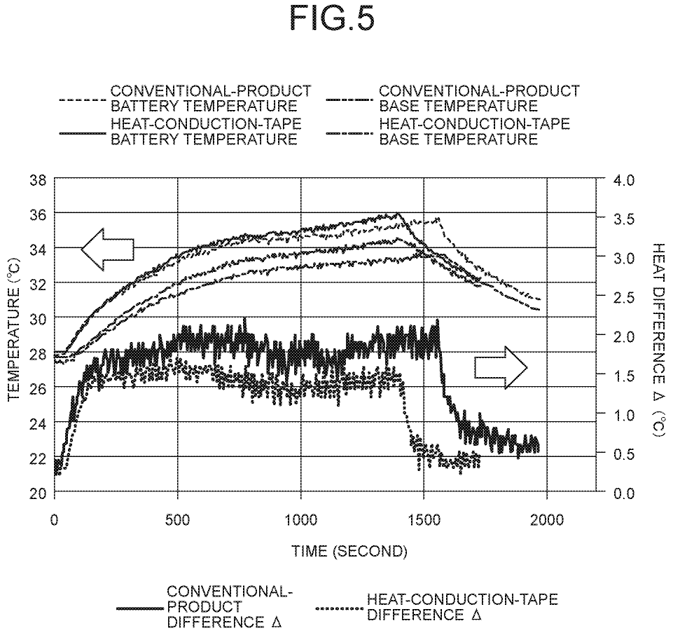

FIG. 5 is a diagram explaining experimental examples of heat dissipation effects. A horizontal axis of FIG. 5 illustrates the time from the start of discharge of the battery cell. A vertical axis in the left side of FIG. 5 illustrates cell temperatures (the temperature of the surface of the battery cell) and base temperatures (the temperature of the chassis near the battery cell). A vertical axis in the right side of FIG. 5 illustrates the difference between the cell temperature and the base temperature. “Conventional product” means a comparative example in which a battery cell is bonded to a chassis with a commercially-available double-faced tape (heat conductivity: 0.05 W/mK) instead of the heat-conduction tape.

The temperatures are measured by using a thermal camera. The capacity of the battery cell is 4000 mAh. A charge/discharge condition is 5000 mA. An aluminum flat plate (120×70×7 mm) is used as the chassis. The width of the heat-conduction tape is 10 mm.

In Example, discharge is stopped 1400 seconds after the discharge is started. With the conventional product, discharge is stopped 1500 seconds after the discharge is started. As illustrated in FIG. 5, the cell temperature and the base temperature are stabilized 500 seconds after the start of the discharge. The difference between the cell temperature and the base temperature when the temperatures are stabilized is about 2.0° C. in the case of the conventional product and is about 1.5° C. in Example. The difference is lower by about 0.5° C. in Example than the conventional product. This is conceivably for a reason that the heat of the battery cell is dissipated well to the chassis via the heat-conduction tape.

### 1-3. Experimental Examples about Measurement Errors in Cell Temperatures

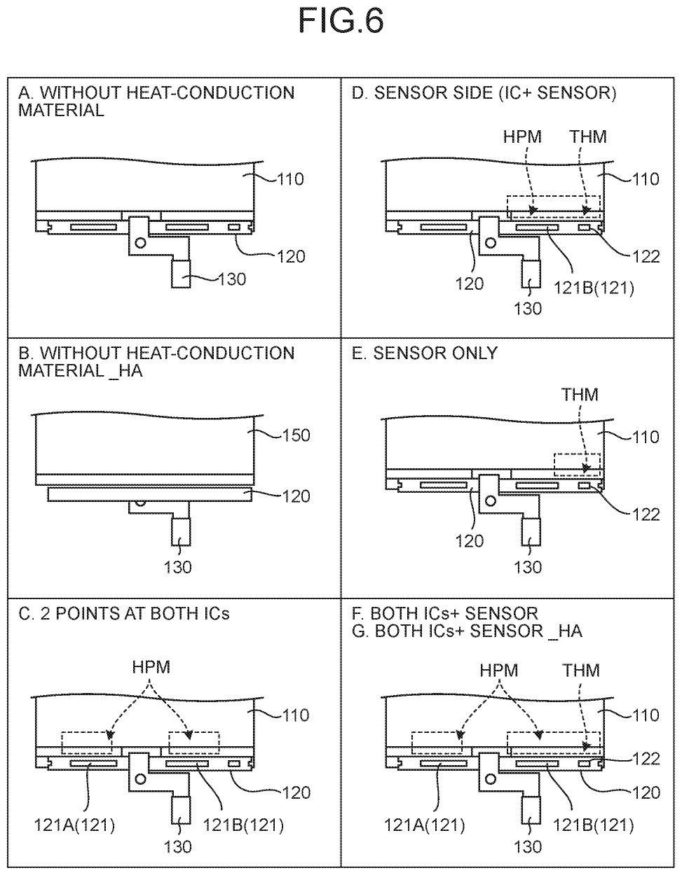

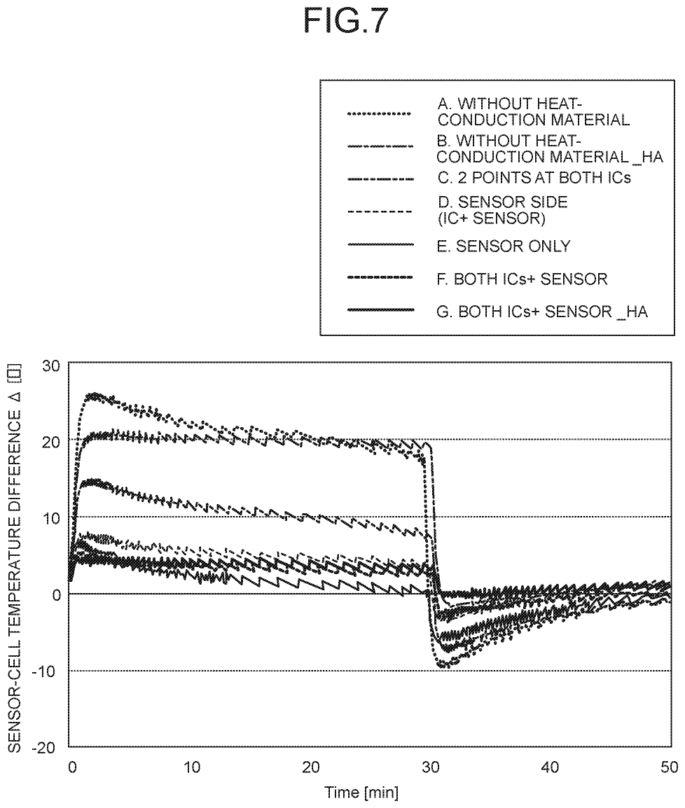

FIG. 6 and FIG. 7 are diagrams describing experimental examples about measurement errors in cell temperatures. FIG. 6 illustrates explanatory diagrams of samples A to G. FIG. 7 is a diagram illustrating differences between the cell temperatures and the sensor temperatures (the measured temperatures of the thermistor 122) of each of the samples A to G. A horizontal axis of FIG. 7 illustrates the time from start of the discharge of the battery cell 110. The discharge is stopped 30 minutes after the start of the discharge. A vertical axis of FIG. 7 illustrates the difference between the cell temperature and the sensor temperature.

The sample A is a sample in which the heat-conduction material 143 is not provided, and the thermistor mount part and the heat-conduction tape are not thermally connected via the heat-conduction material 143. The sample B is a sample in which an outer periphery of the battery cell of the sample A is covered with aluminum foil. The sample C is a sample in which the heat-conduction material 143 is provided at heat-generating-part mount parts HPM (the IC chip 121A, the IC chip 121B) instead of the thermistor mount part THM. The sample D is a sample in which the heat-conduction material 143 is provided at the heat-generating-part mount part HPM (the IC chip 121B) and the thermistor mount part THM. The sample E is a sample in which the heat-conduction material 143 is provided at the thermistor mount part THM. The sample F is a sample in which the heat-conduction material 143 is provided at the heat-generating-part mount parts HPM (the IC chip 121A, the IC chip 121B) and the thermistor mount part THM. The sample G is a sample in which an outer periphery of the battery cell of the sample F is covered with aluminum foil.

As illustrated in FIG. 7, the difference between the cell temperature and the sensor temperature is stabilized 15 minutes after the start of the discharge. The difference between the cell temperature and the sensor temperature when the temperatures are stabilized is the smallest in the case of the sample E. This is conceivably for a reason that the heat-conduction material 143 has efficiently transmitted the heat of the battery cell 110 to the thermistor 122. Also in the sample D, the sample F, and the sample G, the heat-conduction material 143 is provided at the thermistor mount part THM. However, in these samples, the heat-conduction material 143 is provided also at the heat-generating-part mount part HPM. Therefore, the heat generated by the heat-generating part 121 is also transmitted to the thermistor 122, and the difference between the cell temperature and the sensor temperature is larger than that of the sample E. Therefore, it can be understood that the first heat-conduction tape 140A is preferred to be connected to the protection circuit substrate 120 via the heat-conduction material 143 which is selectively provided in the region excluding the heat-generating-part mount part HPM.

### 1-4. Effects

As described above, the electronic device 1 has the battery cell 110, the protection circuit substrate 120, and the heat-conduction tapes 140. A thermistor 122 is mounted on the protection circuit substrate 120. The heat-conduction tapes 140 bond the battery cell 110 to the chassis 200. The first heat-conduction tape 140A is extended from the battery cell 110 to the thermistor mount part THM of the protection circuit substrate 120 and is connected to the thermistor mount part THM via the heat-conduction material 143.

According to this structure, the heat transmitted to the thermistor mount part YHM via the protection circuit substrate 120 is dissipated to the chassis 200 via the first heat-conduction tape 140A. Therefore, the heat generated by the protection circuit substrate 120 does not easily affect the measurement result of the thermistor 122. Also, the heat generated by the battery cell 110 is transmitted to the thermistor 122 via the first heat-conduction tape 140A. Therefore, the cell temperature of the battery cell 110 is detected by the thermistor 122 with high accuracy.

The protection circuit substrate 120 includes the heat-generating part 121. The first heat-conduction tape 140A is connected, via the heat-conduction material 143, to the region of the protection circuit substrate 120 excluding the heat-generating-part mount parts HPM.

According to this structure, transmission of the heat, which has been generated by the heat-generating parts 121, to the thermistor 122 via the first heat-conduction tape 140A can be restricted. Therefore, the measurement accuracy of the cell temperature is enhanced. Also, transmission of the heat, which has been generated by the heat-generating parts 121, to the battery cell 110 via the first heat-conduction tape 140A can be also restricted. Therefore, heat deterioration of the battery cell 110 is also restricted.

The first heat-conduction tape 140A is connected to the protection circuit substrate 120 via the heat-conduction material 143, which is selectively provided in the region excluding the heat-generating-part mount parts HPM.

According to this structure, by the disposition of the heat-conduction material 143, the part at which the first heat-conduction tape 140A is thermally connected to the protection circuit substrate 120 is controlled. Therefore, the degree of freedom in the disposition of the first heat-conduction tape 140A is increased.

The first heat-conduction tape 140A extends from the first end of the battery cell 110, to which the protection circuit substrate 120 is connected, toward a second end of the battery cell 110, which is in the opposite side of the first end.

According to this structure, the temperature of the entire battery cell 110 is sampled well by the first heat-conduction tape 140A which is longitudinally crossing the battery cell 110. Therefore, the detection accuracy of the cell temperature is enhanced.

The heat-conduction tape 140 has the tape main-body part 141 and the tab part 142. The tape main-body part 141 is disposed between the battery cell 110 and the chassis 200. The tab part 142 is connected to a distal end of the tape main-body part 141. The tape main-body part 141 has adhesive layers 146 on both surfaces of an extensible insulating base material 145. Heat-conductive fillers are dispersed in the adhesive layers 146.

According to this structure, the tab part 142 can be used as a pull tab for pulling the battery cell 110 from the chassis 200.

The heat conductivity of the heat-conduction tape 140 is 0.1 W/mK or higher.

According to this structure, the heat-dissipation function and the cell-temperature transmitting function via the heat-conduction tape 140 are enhanced. Therefore, the detection accuracy of the cell temperature is enhanced.

### 2. Second Embodiment

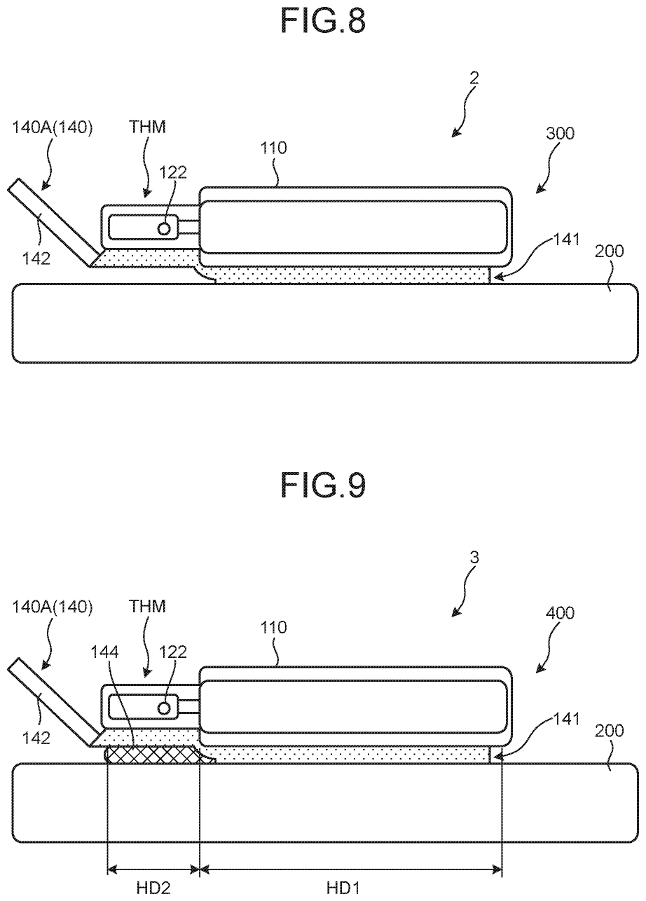

FIG. 8 is a schematic diagram of an electronic device 2 of a second embodiment.

In the present embodiment, a point different from the first embodiment is that a battery pack 300 does not include the heat-conduction material 143. The first heat-conduction tape 140A is extended to the thermistor mount part THM while avoiding the heat-generating-part mount parts HPM and is directly connected to the thermistor mount part THM.

Also in this structure, the heat transmitted to the thermistor mount part YHM via the protection circuit substrate 120 is dissipated to the chassis 200 via the first heat-conduction tape 140A. Therefore, the heat generated by the protection circuit substrate 120 does not easily affect the measurement result of the thermistor 122. Also, the heat generated by the battery cell 110 is transmitted to the thermistor 122 via the first heat-conduction tape 140A. Therefore, the cell temperature of the battery cell 110 is detected by the thermistor 122 with high accuracy. Also, in this structure, since the heat-conduction material 143 is not used, the structure is simplified compared with the first embodiment.

### 3. Third Embodiment

FIG. 9 is a schematic diagram of an electronic device 3 of a third embodiment.

In the present embodiment, a point different from the second embodiment is that a battery pack 400 has a second heat-conduction material 144. The second heat-conduction material 144 is disposed in a gap between the first heat-conduction tape 140A of the part, which is connected to the thermistor mount part THM, and the chassis 200 and connects the first heat-conduction tape 140A to the chassis 200.

According to this structure, in addition to a first heat-dissipation path HD1 via the first heat-conduction tape 140A, a second heat-dissipation path HD2 via the first heat-conduction tape 140A and the second heat-conduction material 144 is formed. The heat transmitted to the thermistor mount part THM via the protection circuit substrate 120 is directly dissipated to the chassis 200 via the first heat-dissipation path HD1 and is dissipated to the chassis 200 via the second heat-dissipation path HD2. Since the heat dissipation paths are increased, the heat transmitted to the thermistor mount part THM is efficiently dissipated to the chassis 200.

### 4. Modification Examples

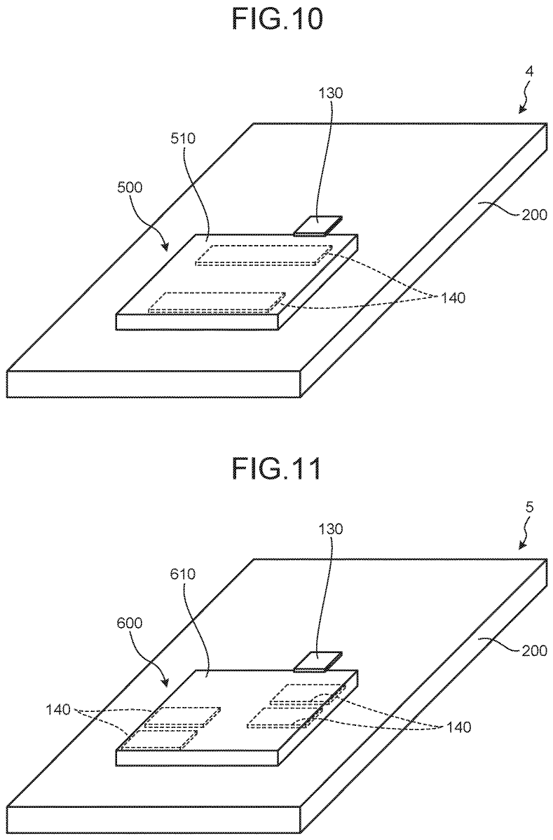

Hereinafter, variations of the disposition of the heat-conduction tape 140 will be described. FIG. 10 is a diagram illustrating an electronic device 4 according to a first modification example. FIG. 11 is a diagram illustrating an electronic device 5 according to a second modification example.

In a battery pack 500 of the first modification example, the heat-conduction tapes 140 are disposed along two sides of the battery cell 110 parallel to the terrace part 110T of a battery cell 510. At an end of the heat-conduction tape 140 disposed at a position adjacent to the terrace part 110T, a branch part, which extends toward the thermistor mount part THM and is omitted in illustration, is formed, and the branch part is connected to the thermistor mount part THM directly or via the heat-conduction material 143.

In a battery pack 600 of the second modification example, the heat-conduction tapes 140 are provided at two corner parts opposed to each other in a diagonal line of a battery cell 610. At the heat-conduction tape 140 provided at one of the corner parts, a branch part, which extends toward the thermistor mount part THM and is omitted in illustration, is formed, and the branch part is connected to the thermistor mount part THM directly or via the heat-conduction material 143.

Also in the first modification example and the second modification example, the effects similar to those of the above described embodiments are obtained.

The effects described in the present description are merely examples and are not limitative, and other effects may be included.

The present technique can also employ following configurations.

(1)

An electronic device comprising:

a battery cell;

a protection circuit substrate on which a thermistor is mounted; and

a heat-conduction tape bonding the battery cell to a chassis, extended from the battery cell to a thermistor mount part of the protection circuit substrate, and connected to the thermistor mount part directly or via a heat-conduction material.

(2)

The electronic device according to (1), wherein

the protection circuit substrate includes a heat-generating part, and

the heat-conduction tape is connected to a region directly or via the heat-conduction material, the region excluding a heat-generating-part mount part of the protection circuit substrate.

(3)

The electronic device according to (2), wherein

the heat-conduction tape is connected to the protection circuit substrate via the heat-conduction material selectively provided in a region excluding the heat-generating-part mount part.

(4)

The electronic device according to (2), wherein

the heat-conduction tape is extended to the thermistor mount part to avoid the heat-generating-part mount part and directly connected to the thermistor mount part.

(5)

The electronic device according to (4), comprising

a second heat-conduction material disposed in a gap between the heat-conduction tape of a part connected to the thermistor mount part and the chassis, the second heat-conduction material connecting the heat-conduction tape to the chassis.

(6)

The electronic device according to any one of (1) to (5), wherein

the heat-conduction tape extends from a first end of the battery cell connected to the protection circuit substrate toward a second end of the battery cell in an opposite side of the first end.

(7)

The electronic device according to any one of (1) to (6), wherein

the heat-conduction tape has a tape main-body part disposed between the battery cell and the chassis and has a tab part connected to a distal end of the tape main-body part,

the tape main-body part has an adhesive layer on both surfaces of an extensible insulating base material, and

a heat-conductive filler is dispersed in the adhesive layer.

(8)

The electronic device according to any one of (1) to (7), wherein

the heat-conduction tape has heat conductivity of 0.1 W/mK or higher.

### REFERENCE SIGNS LIST

### 1, 2, 3, 4, 5 ELECTRONIC DEVICE

### 110 BATTERY CELL

### 120 PROTECTION CIRCUIT SUBSTRATE

### 121 HEAT-GENERATING PART

### 122 THERMISTOR

### 140 HEAT-CONDUCTION TAPE

### 141 TAPE MAIN-BODY PART

### 142 TAB PART

### 143 HEAT-CONDUCTION MATERIAL

### 144 SECOND HEAT-CONDUCTION MATERIAL

### 145 INSULATING BASE MATERIAL

### 146 ADHESIVE LAYER

### 200 CHASSIS

### HPM HEAT-GENERATING-PART MOUNT PART

### THM THERMISTOR MOUNT PART

1. An electronic device comprising:
a battery cell;
a protection circuit substrate on which a thermistor is mounted; and
a heat-conduction tape bonding the battery cell to a chassis, extended from the battery cell to a thermistor mount part of the protection circuit substrate, and connected to the thermistor mount part directly or via a heat-conduction material.

2. The electronic device according to claim 1, wherein
the protection circuit substrate includes a heat-generating part, and
the heat-conduction tape is connected to a region directly or via the heat-conduction material, the region excluding a heat-generating-part mount part of the protection circuit substrate.

3. The electronic device according to claim 2, wherein
the heat-conduction tape is connected to the protection circuit substrate via the heat-conduction material selectively provided in a region excluding the heat-generating-part mount part.

4. The electronic device according to claim 2, wherein
the heat-conduction tape is extended to the thermistor mount part to avoid the heat-generating-part mount part and directly connected to the thermistor mount part.

5. The electronic device according to claim 4, comprising
a second heat-conduction material disposed in a gap between the heat-conduction tape of a part connected to the thermistor mount part and the chassis, the second heat-conduction material connecting the heat-conduction tape to the chassis.

6. The electronic device according to claim 1, wherein
the heat-conduction tape extends from a first end of the battery cell connected to the protection circuit substrate toward a second end of the battery cell in an opposite side of the first end.

7. The electronic device according to claim 1, wherein
the heat-conduction tape has a tape main-body part disposed between the battery cell and the chassis and has a tab part connected to a distal end of the tape main-body part,
the tape main-body part has an adhesive layer on both surfaces of an extensible insulating base material, and
a heat-conductive filler is dispersed in the adhesive layer.

8. The electronic device according to claim 1, wherein
the heat-conduction tape has heat conductivity of 0.1 W/mK or higher.
